(19) United States
(12) Patent Application Publication
(10) Pub. No.: US 2025/0150230 A1
(43) Pub. Date: May 8, 2025

(54) METHOD FOR AVOIDING MEASUREMENT ERRORS DUE TO CENTER FREQUENCY DISCREPANCIES IN NR CARRIER PHASE POSITIONING

(71) Applicant: Nokia Technologies Oy, Espoo (FI)

(72) Inventors: Abdurrahman FOUDA, Naperville, IL (US); Hyun-Su CHA, Naperville, IL (US); Satya Krishna JOSHI, Oulu (FI)

(21) Appl. No.: 18/932,774

(22) Filed: Oct. 31, 2024

Related U.S. Application Data
(60) Provisional application No. 63/596,049, filed on Nov. 3, 2023.

(51) Int. Cl. H04L 5/00; H04W 64/00

(52) U.S. Cl. CPC H04L 5/0048; H04W 64/00

(57) ABSTRACT

Systems and apparatus for avoiding measurement errors include transmitting, by a LMF, to at least one of a network entity or a user equipment, a request to obtain at least one carrier phase measurement using at least one center frequency identifier configuration for at least one positioning reference signal, wherein the at least one positioning reference signal includes at least one uplink SRS or DL PRS.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for avoiding measurement errors.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, by a LMF, to at least one of a network entity or a UE, a request to obtain at least one CP measurement using at least one center frequency identifier configuration for at least one PRS. The at least one PRS comprises at least one UL SRS or DL PRS.

In accordance with certain example embodiments, an apparatus may include means for transmitting, to at least one of a network entity or a UE, a request to obtain at least one CP measurement using at least one center frequency identifier configuration for at least one PRS. The at least one PRS comprises at least one UL SRS or DL PRS.

In accordance with various example embodiments, a non-transitory computer readable medium may include program instructions that, when executed by an apparatus, cause the apparatus to perform at least a method. The method may include transmitting, to at least one of a network entity or a UE, a request to obtain at least one CP measurement using at least one center frequency identifier configuration for at least one PRS. The at least one PRS comprises at least one UL SRS or DL PRS.

In accordance with some example embodiments, a computer program product may perform a method. The method may include transmitting, to at least one of a network entity or a UE, a request to obtain at least one CP measurement using at least one center frequency identifier configuration for at least one PRS. The at least one PRS comprises at least one UL SRS or DL PRS.

In accordance with certain example embodiments, an apparatus may include at least one processor and at least one memory storing instructions that, when executed by the at least one processor, cause the apparatus at least to transmit, to at least one of a network entity or a UE, a request to obtain at least one CP measurement using at least one center frequency identifier configuration for at least one PRS. The at least one PRS comprises at least one UL SRS or DL PRS.

In accordance with various example embodiments, an apparatus may include transmitting circuitry configured to perform transmitting, to at least one of a network entity or a UE, a request to obtain at least one CP measurement using at least one center frequency identifier configuration for at least one PRS. The at least one PRS comprises at least one UL SRS or DL PRS.

In accordance with some example embodiments, a method may include receiving, by a UE, at least one center frequency identifier configuration for a DL PRS within a PFL. The method may further include receiving, by the UE, a request to perform CP measurement based on the at least one center frequency identifier configuration.

In accordance with certain example embodiments, an apparatus may include means for receiving at least one center frequency identifier configuration for a DL PRS within a PFL. The apparatus may further include means for receiving a request to perform CP measurement based on the at least one center frequency identifier configuration.

In accordance with various example embodiments, a non-transitory computer readable medium may include program instructions that, when executed by an apparatus, cause the apparatus to perform at least a method. The method may include receiving at least one center frequency identifier configuration for a DL PRS within a PFL. The method may further include receiving a request to perform CP measurement based on the at least one center frequency identifier configuration.

In accordance with some example embodiments, a computer program product may perform a method. The method may include receiving at least one center frequency identifier configuration for a DL PRS within a PFL. The method may further include receiving a request to perform CP measurement based on the at least one center frequency identifier configuration.

In accordance with certain example embodiments, an apparatus may include at least one processor and at least one memory storing instructions that, when executed by the at least one processor, cause the apparatus at least to receive at least one center frequency identifier configuration for a DL PRS within a PFL. The instructions, when executed by the at least one processor, may further cause the apparatus at least to receive a request to perform CP measurement based on the at least one center frequency identifier configuration.

In accordance with various example embodiments, an apparatus may include receiving circuitry configured to perform receiving at least one center frequency identifier configuration for a DL PRS within a PFL. The apparatus may further include receiving circuitry configured to perform receiving a request to perform CP measurement based on the at least one center frequency identifier configuration.

In accordance with some example embodiments, a method may include transmitting to a LMF, by a network entity, UL SRS configuration configured for at least one of a UE or a PRU UL SRS transmission. The method may further include receiving from the LMF, by the network entity, at least one center frequency identifier configuration for the UL SRS. The method may further include receiving from the LMF, by the network entity, a request to obtain one or more CP measurements based on the at least one center frequency identifier configuration. The method may further include performing one or more CP measurements associated with at least one center frequency ID configured by the at least one center frequency identifier configuration for the UL SRS. The method may further include transmitting to the LMF, by the network entity, the one or more measurements and the associated at least one center frequency ID.

In accordance with certain example embodiments, an apparatus may include means for transmitting to a LMF UL SRS configuration configured for at least one of a UE or a PRU UL SRS transmission. The apparatus may further include means for receiving from the LMF at least one center frequency identifier configuration for the UL SRS. The apparatus may further include means for receiving from the LMF a request to obtain one or more CP measurements based on the at least one center frequency identifier configuration. The apparatus may further include means for performing one or more CP measurements associated with at least one center frequency ID configured by the at least one center frequency identifier configuration for the UL SRS. The apparatus may further include means for transmitting to the LMF the one or more measurements and the associated at least one center frequency ID.

In accordance with various example embodiments, a non-transitory computer readable medium may include program instructions that, when executed by an apparatus, cause the apparatus to perform at least a method. The method may include transmitting to a LMF UL SRS configuration configured for at least one of a UE or a PRU UL SRS transmission. The method may further include receiving from the LMF at least one center frequency identifier configuration for the UL SRS. The method may further include receiving from the LMF a request to obtain one or more CP measurements based on the at least one center frequency identifier configuration. The method may further include performing one or more CP measurements associated with at least one center frequency ID configured by the at least one center frequency identifier configuration for the UL SRS. The method may further include transmitting to the LMF the one or more measurements and the associated at least one center frequency ID.

In accordance with some example embodiments, a computer program product may perform a method. The method may include transmitting to a LMF UL SRS configuration configured for at least one of a UE or a PRU UL SRS transmission. The method may further include receiving from the LMF at least one center frequency identifier configuration for the UL SRS. The method may further include receiving from the LMF a request to obtain one or more CP measurements based on the at least one center frequency identifier configuration. The method may further include performing one or more CP measurements associated with at least one center frequency ID configured by the at least one center frequency identifier configuration for the UL SRS. The method may further include transmitting to the LMF the one or more measurements and the associated at least one center frequency ID.

In accordance with certain example embodiments, an apparatus may include at least one processor and at least one memory storing instructions that, when executed by the at least one processor, cause the apparatus at least to transmit to a LMF UL SRS configuration configured for at least one of a UE or a PRU UL SRS transmission. The instructions, when executed by the at least one processor, may further cause the apparatus at least to receive from the LMF at least one center frequency identifier configuration for the UL SRS. The instructions, when executed by the at least one processor, may further cause the apparatus at least to receive from the LMF a request to obtain one or more CP measurements based on the at least one center frequency identifier configuration. The instructions, when executed by the at least one processor, may further cause the apparatus at least to perform one or more CP measurements associated with at least one center frequency ID configured by the at least one center frequency identifier configuration for the UL SRS. The instructions, when executed by the at least one processor, may further cause the apparatus at least to transmit to the LMF the one or more measurements and the associated at least one center frequency ID.

In accordance with various example embodiments, an apparatus may include transmitting circuitry configured to perform transmitting to a LMF UL SRS configuration configured for at least one of a UE or a PRU UL SRS transmission. The apparatus may further include receiving circuitry configured to perform receiving from the LMF at least one center frequency identifier configuration for the UL SRS. The apparatus may further include receiving circuitry configured to perform receiving from the LMF a request to obtain one or more CP measurements based on the at least one center frequency identifier configuration. The apparatus may further include measuring circuitry configured to perform performing one or more CP measurements associated with at least one center frequency ID configured by the at least one center frequency identifier configuration for the UL SRS. The apparatus may further include transmitting circuitry configured to perform transmitting to the LMF the one or more measurements and the associated at least one center frequency ID.

In accordance with some example embodiments, a method may include receiving, by a PRU, from a LMF, at least one center frequency identifier configuration for a DL PRS within a PFL. The method may further include receiving, by the positioning reference unit, a request to perform CP measurement based on the at least one center frequency identifier configuration. The method may further include performing, by the positioning reference unit, at least one CP measurement associated with at least one center frequency ID configured by the at least one center frequency identifier configuration. The method may further include transmitting, by the positioning reference unit, to the LMF a report on the at least one CP measurement and the associated at least one center frequency ID for the at least one CP measurement.

In accordance with certain example embodiments, an apparatus may include means for receiving, from a LMF, at least one center frequency identifier configuration for a DL PRS within a PFL. The apparatus may further include means for receiving a request to perform CP measurement based on the at least one center frequency identifier configuration. The apparatus may further include means for performing at least one CP measurement associated with at least one center frequency ID configured by the at least one center frequency identifier configuration. The apparatus may further include means for transmitting to the LMF a report on the at least one CP measurement and the associated at least one center frequency ID for the at least one CP measurement.

In accordance with various example embodiments, a non-transitory computer readable medium may include program instructions that, when executed by an apparatus, cause the apparatus to perform at least a method. The method may further include receiving, from a LMF, at least one center frequency identifier configuration for a DL PRS within a PFL. The method may further include receiving a request to perform CP measurement based on the at least one center frequency identifier configuration. The method may further include performing at least one CP measurement associated with at least one center frequency ID configured by the at least one center frequency identifier configuration. The method may further include transmitting to the LMF a report on the at least one CP measurement and the associated at least one center frequency ID for the at least one CP measurement.

In accordance with some example embodiments, a computer program product may perform a method. The method may further include receiving, from a LMF, at least one center frequency identifier configuration for a DL PRS within a PFL. The method may further include receiving a request to perform CP measurement based on the at least one center frequency identifier configuration. The method may further include performing at least one CP measurement associated with at least one center frequency ID configured by the at least one center frequency identifier configuration. The method may further include transmitting to the LMF a report on the at least one CP measurement and the associated at least one center frequency ID for the at least one CP measurement.

In accordance with certain example embodiments, an apparatus may include at least one processor and at least one memory storing instructions that, when executed by the at least one processor, cause the apparatus at least to receive, from a LMF, at least one center frequency identifier configuration for a DL PRS within a PFL. The instructions, when executed by the at least one processor, may further cause the apparatus at least to receive a request to perform CP measurement based on the at least one center frequency identifier configuration. The instructions, when executed by the at least one processor, may further cause the apparatus at least to perform at least one CP measurement associated with at least one center frequency ID configured by the at least one center frequency identifier configuration. The instructions, when executed by the at least one processor, may further cause the apparatus at least to transmit to the LMF a report on the at least one CP measurement and the associated at least one center frequency ID for the at least one CP measurement.

In accordance with various example embodiments, an apparatus may include receiving circuitry configured to perform receiving, from a LMF, at least one center frequency identifier configuration for a DL PRS within a PFL. The apparatus may further include receiving circuitry configured to perform receiving a request to perform CP measurement based on the at least one center frequency identifier configuration. The apparatus may further include measuring circuitry configured to perform performing at least one CP measurement associated with at least one center frequency ID configured by the at least one center frequency identifier configuration. The apparatus may further include transmitting circuitry configured to perform transmitting to the LMF a report on the at least one CP measurement and the associated at least one center frequency ID for the at least one CP measurement.

### BRIEF DESCRIPTION OF THE DRA WINGS

For a proper understanding of example embodiments, reference should be made to the accompanying drawings, wherein:

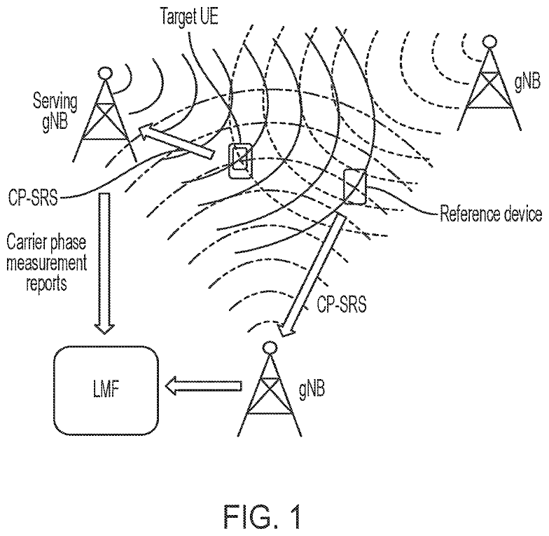

FIG. 1 illustrates an example of an uplink carrier phase positioning;

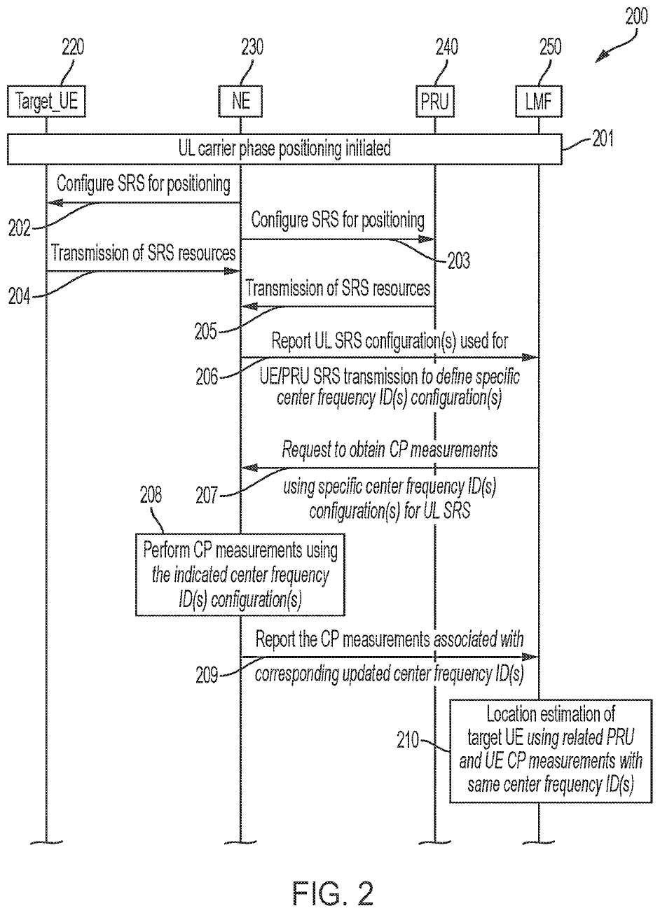

FIG. 2 illustrates an example of a signaling diagram according to certain example embodiments;

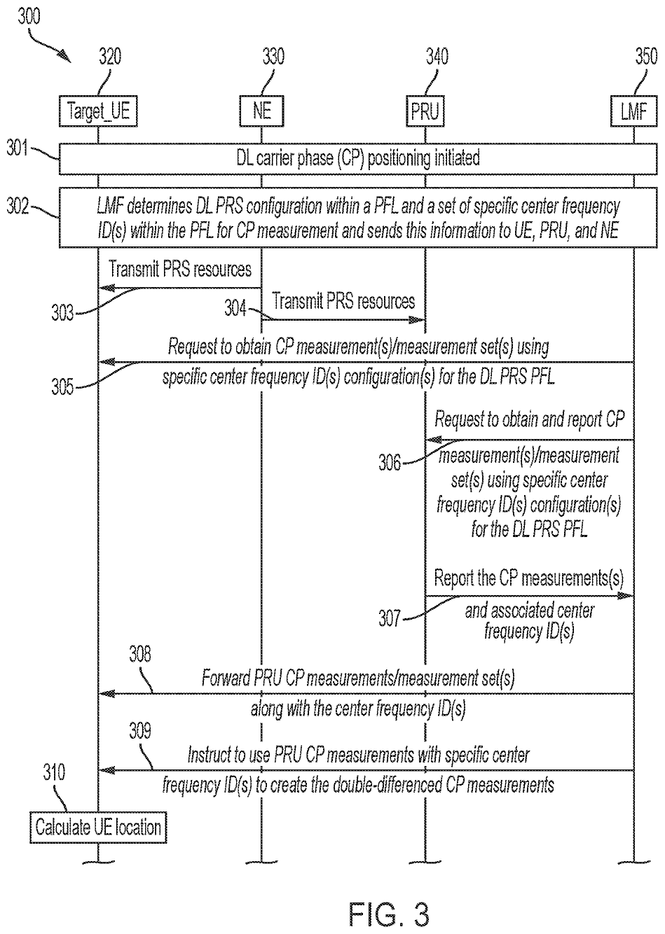

FIG. 3 illustrates an example of another signaling diagram according to some example embodiments;

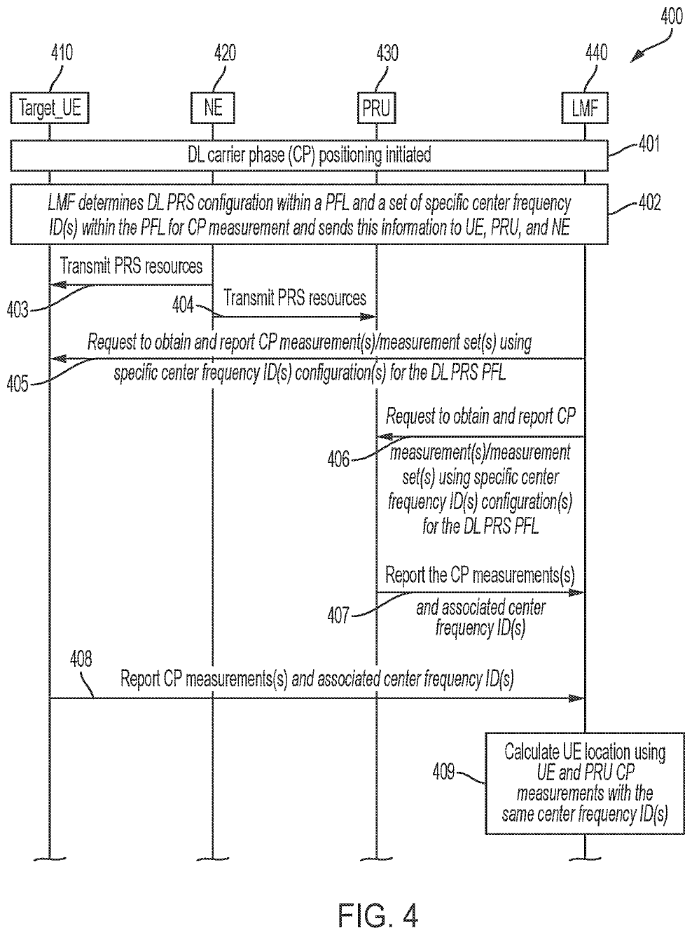

FIG. 4 illustrates an example of another signaling diagram according to various example embodiments;

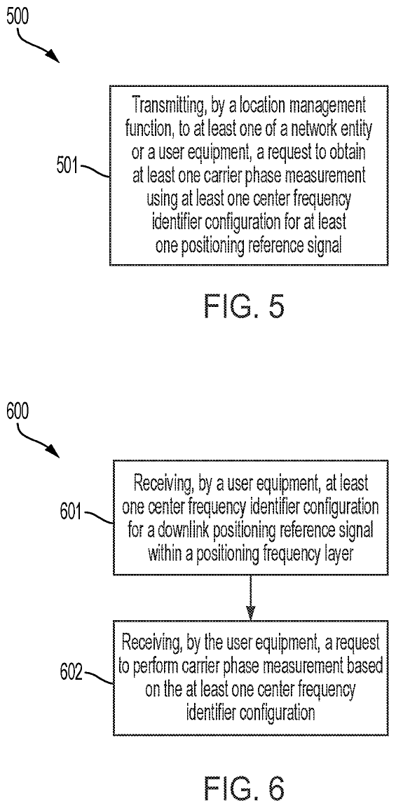

FIG. 5 illustrates an example of a flow diagram of a method according to certain example embodiments;

FIG. 6 illustrates an example of a flow diagram of a method according to some example embodiments;

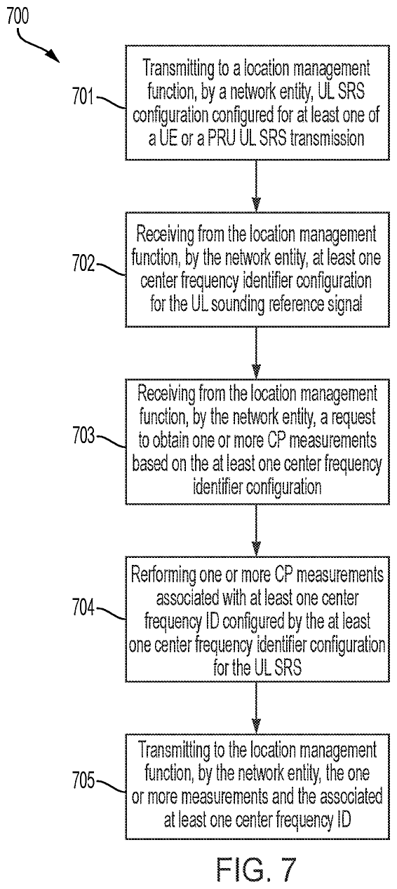

FIG. 7 illustrates an example of a flow diagram of a method according to various example embodiments;

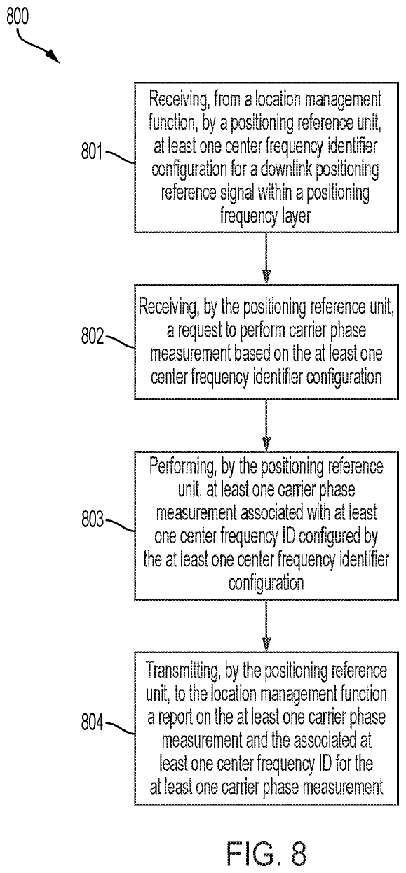

FIG. 8 illustrates an example of a flow diagram of a method according to certain example embodiments;

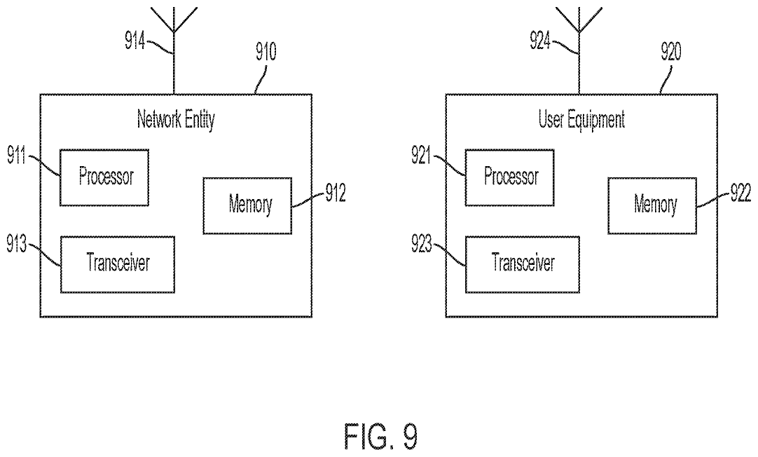

FIG. 9 illustrates an example of various network devices according to some example embodiments; and

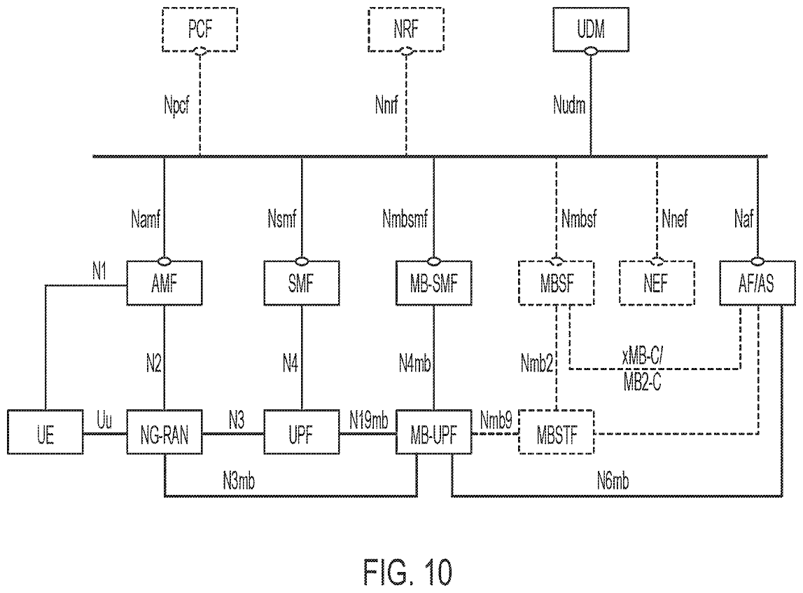

FIG. 10 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for avoiding measurement errors is not intended to limit the scope of certain example embodiments, but is instead representative of selected example embodiments.

3GPP RAN1 is developing carrier phase (CP) positioning in conjunction with currently supported positioning techniques. This may include specifying physical layer measurements and signaling to support NR downlink (DL) and uplink (UL) CP positioning (CPP) for UE-based, UE-assisted, and NG-RAN node assisted positioning. For example, existing DL positioning reference signals (PRSs) and UL sounding reference signals (SRSs) for positioning may be used for NR CP measurements and may specify measurements that are limited to a single carrier/positioning frequency layer (PFL). This may also include specifying corresponding new core requirements, as well as identifying and specifying the impact on the existing RAN4 specification, including radio resource management (RRM) measurements without measurement gaps in connected and inactive mode (including PRS measurement period/reporting) and procedures.

FIG. 1 illustrates a basic architecture of UL CPP. In NG-RAN node-assisted UL-based CPP, a target UE and positioning reference unit (PRU) may transmit UL SRSs, and multiple transmission and reception points (TRPs) may measure reference signal carrier phase (RSCP) measurements. UL RSCP measurements may then be reported to a location management function (LMF) that may estimate the target UE location based on the time measurements, phase measurements of the target UE and PRU, and/or the locations of the PRU and/or TRPs. In some example embodiments, a base station (e.g., gNB) may have at least one transmission and reception point (TRP) connected to it to facilitate receiving and transmitting signals from and to, for example, a UE, based on a control by the base station. Thus, within a cell coverage, there may be multiple TRPs. At least one TRP may be associated with a physical cell ID. In some example embodiments, time measurements may include DL reference signal time difference RSTD (RSTD), UE Rx-Tx time difference measurements, relative time of arrival (RTOA) measurements, and/or gNB Rx-Tx time difference measurements.

DL PRSs may be transmitted to a target UE and PRU in DL-based CPP. DL-based CPP may be applied in UE-assisted or UE-based modes. For instance, in the UE-assisted mode, the target UE/PRU may measure the DL RSCP measurements and report them to the LMF. The LMF may then calculate the target UE location based on timing measurements, phase measurements made by the target UE and PRU, and/or locations of the TRPs. In contrast, in the UE-based mode, the target UE may measure the DL RSCP measurements, receive PRU measurements from the LMF, and calculate its own location based on the timing measurements, phase measurements performed by the UE, PRU measurements received from the LMF, and locations of TPRs and PRU. Furthermore, UE-based positioning may not require CP measurements from the PRU; without the measurements from PRU, UE-based positioning may be feasible at the target UE.

For transmitted SRS resources from the k^{th} UE, the phase measurement at the i^{th} TRP may be determined according to:

$${φ}_{ik} = {d}_{ik} + c ( {δ}_{k} - {δ}_{i} ) + λ {N}_{ik} , \qquad ( 1 )$$

where

$${φ}_{ik} = \frac{1}{2 π} {\hat{φ}}_{ik}$$

may denote the phase measurement in cycles and avoid repeated use of 2π; φᵢₖ may denote actual geographical distance between the k^{th} UE and the i^{th} TRP; c may denote speed of light; δₖ may denote internal clock bias at the k^{th} UE; δᵢ may denote internal clock bias at the i^{th} TRP; and Nᵢₖ may denote integer ambiguity of the propagated wavelength. Similar to (1), the same equation may be derived for the phase measurement at the j^{th} TRP, such that

φⱼₖ=dⱼₖ+c(δₖ-δⱼ)+λNⱼₖ.

The unknown phase shifts due to the oscillator phases at the TRP and UE may add ambiguity to the estimated phase and impair the positioning estimation accuracy. The single difference measurement may be used to eliminate the internal clock bias at the k^{th} UE by subtracting φⱼₖ form φᵢₖ as follows:

$${Δφ}_{ij}^{k} = Δ {d}_{ij}^{k} + c Δ {δ}_{ij}^{k} + λΔ {N}_{ij}^{k} , \qquad ( 2 )$$

where

Δφᵢⱼ^{k}−φⱼₖ,Δdᵢⱼ^{k}=dᵢₖ−dⱼₖ,Δδᵢⱼ^{k}=δⱼ−δᵢ, and Δnᵢⱼ^{k}=Nᵢₖ−Nⱼₖ.

From this single differential operation, the UE clock bias may be cancelled, similar to a RTOA measurement of the UL-time difference of arrival (TDOA) method. Similarly, the clock error between TRPs may be removed by conducting double differential measurements, which may be performed by subtracting the single-differenced measurements of the PRU from that of the k^{th} UE.

If the p^{th} UE is the PRU, for the transmitted SRS from the p^{th} PRU, the single difference measurement between the 4^{th} and j^{th}TRPs may be written as

Δφᵢⱼ^{p}=Δdᵢⱼ^{p}+cΔδᵢⱼ^{p}+λΔNᵢⱼ^{p},

where

Δφᵢⱼ^{p}=φᵢₚ^{jp},Δdᵢⱼ^{p}=dᵢₚ−dⱼₚ,Δδᵢⱼ^{p}=δᵢ−δⱼ,

and

ΔNᵢⱼ^{p}=Nᵢₚ−Nⱼₚ.

The clock error between the i^{th} and j^{th}TRPs (i.e., Δδᵢⱼ^{p} and Δδᵢⱼ^{k}) is a common term between Δφᵢⱼ^{p}, and Δφᵢⱼ^{k}, and may not depend on the UE/PRU index under some conditions. They may be eliminated by subtracting Δφᵢⱼ^{p} from Δφᵢⱼ^{k} as follows:

$${ΔΔφ}_{ij}^{kp} = ΔΔ {d}_{ij}^{kp} + λΔΔ {N}_{ij}^{kp} \qquad ( 3 )$$

where ΔΔφᵢⱼ^{kp}=Δφᵢⱼ^{k}−Δφᵢⱼ^{p}, ΔΔdᵢⱼ^{kp}=Δdᵢⱼ^{k}−Δdᵢⱼ^{p}, and ΔΔNᵢⱼ^{kp}=ΔNᵢⱼ^{k}−ΔNᵢⱼ^{p}. Thus, the clock error between the target UE and TRP, and the clock errors between TRPs, may be removed using the single and double differential measurements, respectively. The only remining ambiguity is the integer ambiguity parameter (i.e., ΔΔNᵢⱼ^{kp}). The entity calculating the UE location (i.e., UE in DL CPP UE-based mode, or LMF in DL CPP UE-assisted and UL CPP NG-RAN node-assisted modes) may estimate ΔΔᵢⱼ^{kp} using the associated time measurements with the CP measurements of the target UE and PRU.

DL RSCP/RSCP difference (RSCPD) and UL RSCP measurements may include a variety of definitions. For example, a specific RF frequency associated with a DL CP measurement may be defined as the center frequency of the DL PFL by default. Similarly, a specific RF frequency associated with a UL CP measurement may be defined, by default, as the center frequency of the transmission bandwidth of the SRS for positioning purposes. When DL RSCPD/RSCP measurements are reported together with the DL RSTD/UE Rx-Tx time difference measurements, the DL RSCPD/RSCP measurements may be obtained from a single DL PFL only.

A UE having the capability to support CPP in RRC_CONNECTED/RRC_INACTIVE/RRC_IDLE state may measure the DL PRS from the whole DL PFL (i.e., PRS measurement is not limited within its initial DL BWP). The RF frequency associated with the DL RSCP/RSCPD when UE is in RRC_INACTIVE/RRC_IDLE state may be defined in a similar way as a UE in RRC_CONNECTED state. In UL CPP, a base station may have the flexibility to perform the UL RSCP measurements from all or a part of the bandwidth configured for the SRS resource. Similarly, in DL CPP, a UE may have the flexibility to measure the DL RSCP and RSCPD measurements using all or part of the bandwidth configured for the DL PRS transmissions. Thus, there is a need to avoid positioning errors caused by center frequency discrepancies between the CP measurements and reference signals transmissions in the UL and DL CPP.

There is a need to avoid using center frequencies for the UL and DL CP measurements different than the center frequencies used for the transmission of the UL SRS and DL PRS resources. There is also a need to inform the entity calculating the UE location (e.g., UE in DL CPP UE-based mode, or LMF in DL CPP UE-assisted and UL CPP NG-RAN node-assisted modes) with any center frequencies used for the CP measurements, which may not be the same as the center frequency used for the SRS and PRS transmissions given the above explained flexibility that the measuring entity (e.g., gNB in UL CPP, or UE in DL CPP) may have.

Certain example embodiments described herein may have various technical effects to overcome the disadvantages described above. For example, certain example embodiments may relate to techniques for avoiding the center frequency errors in reporting the UL and DL CP measurements to improve the target positioning estimation accuracy of CPP methods. For example, in UL CPP, a base station may have the flexibility to measure the UL RSCP measurements from all or part of the bandwidth used for the SRS transmission. Similarly, in DL CPP, the UE may have flexibility to measure the DL RSCP/RSCPD measurements using all or part of the resource blocks (RBs) used for the DL PRS transmissions. Thus, certain example embodiments discussed below are directed to improvements in computer-related technology.

As discussed above, 2 of equation (1) above is from a center frequency. To convert the CP measurement into distance metric, the center frequency of the CP measurement may be fixed for the PRS/SRS transmission based on PRS/SRS bandwidth configuration. The LMF may provide PRS configuration, wherein each PRS resource is associated with a PFL; thus, the LMF may already know the center frequency information on the PRS. However, the UE/gNB may be configured to perform CP measurements based on a part of the configured PRS/SRS bandwidth. The UE/gNB may obtain multiple CP measurements within a PFL or a component carrier, but the center frequency of each measurement may not be aligned with the center frequency of the PFL/CC. Thus, the center frequency of the measurement may be different than known by the LMF.

Furthermore, as noted above, single differential measurements, double differential measurements, and timing measurements may be used in CPP to eliminate the unknown phase offsets between the target UE and TRP, between different TRPs, and resolve the integer ambiguity problem, respectively. This is under the assumption that the UL and DL CP measurements have a center frequency that is the same as the center frequency used for transmitting the UL SRS and DL PRS resources. However, the UL and DL CP measurements may have a center frequency that differs from the center frequency used for transmitting the UL SRS and DL PRS resources. Having discrepancies between the center frequencies used for CP measurements and RSs transmissions may cause positioning errors, and result in the failure of the CPP method to estimate the UE location preventing it from achieving the target positioning estimation accuracy.

Certain example embodiments may enable an LMF to instruct the gNB in UL CPP, or a UE and PRU in DL CPP, to report CP measurements using a predefined/configured group of center frequency IDs that span the bandwidth of SRS transmission in UL CPP, or the DL PFL of PRS transmission in DL CPP. Some example embodiments may also enable the gNB, UE, and/or PRU to provide the LMF with multiple sets of CP measurements, wherein each set may correspond to a specific predefined/configured center frequency based on the RB configurations of SRS and/or PRS resources while maintaining a relative phase coherence across each set of the CP measurements. Thus, positioning errors due to center frequency discrepancies of the CP measurements may be avoided to improve target positioning estimation accuracy. Various example embodiments may also allow the LMF to receive valid information about any center frequencies used to obtain the CP measurements to be able to calculate the UE location using the reported CP measurements by gNBs (in UL CPP), or target UE and PRU (in DL CPP). Certain example embodiments may be configured for the target UE and PRU with new behavior and signaling that involves the serving/neighbor gNBs and LMF and may be implemented for the UL CPP and DL CPP (UE-based and UE-assisted modes). As discuss herein, in various example embodiments, a CP measurement may represent at least one RSCP and/or RSCPD measurement.

FIG. 2 illustrates an example of a signaling diagram 200 depicting a network-based UL CPP mode, such as a NG-RAN node-assisted mode. Target UE 220 and PRU 240 may be similar to UE 920. NE 230 and LMF 250 may be similar to NE 910, as illustrated in FIG. 9, according to certain example embodiments.

At operation 201, UL CP positioning may be initiated between target UE 220, NE 230 (e.g., gNB, or TRPs of a gNB), PRU 240, and LMF 250. For example, target UE 220 and PRU 240 may request NE 230 to provide the necessary UL SRS configurations.

At operation 202, NE 230 may configure SRS resources for positioning with target UE 220. Similarly, at operation 203, NE 230 may configure SRS resources for positioning with PRU 240.

At operation 204, target UE 220 may transmit UL SRS resources to NE 230, and at operation 205, PRU 240 may transmit UL SRS resources to NE 230.

At operation 206, NE 230 may transmit to LMF 250 UL SRS configurations configured for the UE/PRU SRS transmissions to define specific center frequency identifiers configurations. LMF 250 may need to know and be notified whether the UL SRS resources may be configured using contiguous or non-contiguous sets of RBs to define the specific center frequency ID configurations that TRPs may use to obtain the UL CP measurements.

In various example embodiments, LMF 250 may transmit a center frequency identifier configuration to NE 230, based on which NE 230 may perform one or more UL CP measurements. LMF 250 may transmit a request to NE 230 to perform the measurement. In certain example embodiments, as illustrated in FIG. 2, the request may include a specific center frequency ID. Specifically, at operation 207, LMF 250 may transmit to NE 230 a request to obtain UL CP measurements using specific center frequency ID configurations for UL SRS. In particular, LMF 250 may instruct NE 230 with specific center frequency IDs configurations for the SRS bandwidth, and requests NE 230 to obtain UL CP measurements using these center frequency IDs. In some example embodiments, UL CP measurements may be made at the TRP or the gNB by using UL reference signal such as SRS dedicated for positioning or SRS for multiple input multiple output (MIMO).

In certain example embodiments, LMF 250 may provide NE 230 with a pool of center frequency IDs per a component carrier (CC) and/or a UL bandwidth part. NE 230, subject to the network's capabilities, may only be allowed to obtain the CP measurements using these center frequency IDs, wherein each center frequency ID may be used to obtain a single CP measurement.

In various example embodiments, LMF 250 may provide NE 230 with the center frequency of the SRS bandwidth and a granularity step A. NE 230, subject to the network's capability, may be allowed to obtain the CP measurements only using quantized center frequencies determined by fc±n Δ, where fc is the center frequency of the SRS bandwidth, and n is the CP measurement ID. Here, Δ may be defined as the sub-carrier spacing (SCS) and/or an integer multiple of the SCS. For example, CP measurement #1 may be obtained using center frequency fc±1*Δ, and CP measurement #2 may be obtained using center frequency fc±2*Δ.

In certain example embodiments, LMF 250 may provide NE 230 with a pool of center frequency IDs per a CC and/or a UL bandwidth part, where NE 230 may obtain a set of multiple CP measurements using a single center frequency ID. As an example, when CP measurements are obtained using contiguous RBs of SRS, center frequency ID #1 may be used to obtain CP measurement set #1 that contains CP measurement #1 obtained from SRS resource #1 transmitted from UE X, and CP measurement #2 obtained from SRS resource #2 transmitted from UE Y. As another example, when CP measurements are obtained using non-contiguous RBs of SRS, center frequency ID #1 may be used to obtain CP measurement set #1 that contains CP measurement #1 from SRS resources #1,3 transmitted from UE X, and CP measurement #2 from SRS resource #2,4 transmitted from UE Y. LMF 250 may obtain the RSCPD measurements using only the UL CP measurements/measurement sets of different NEs that have the same center frequency ID.

At operation 208, NE 230 may receive the SRS transmissions from the target UE 220 and PRU 240, obtain CP measurements/measurement sets using the above center frequency IDs indicated by LMF 250, and/or, at operation 209, report to LMF 250 the CP measurements/measurement sets and the corresponding used center frequency IDs.

NE 230 may use the UL SRSs received from target UE 220 and PRU 240 to perform and obtain the UL CP measurements/measurement sets using one of the above center frequency IDs provided by LMF 250, and report them to LMF 250 along with the used center frequency IDs. TRPs may report a set of CP measurements and their associated center frequency IDs, where each CP measurement is obtained using a single center frequency ID. In another example, TRPs may report multiple CP measurement sets, where each set is associated with a single center frequency ID.

In various example embodiments, a TRP, subject to the network's capability, may report updated center frequency information of the UL CP measurements obtained from the received UL SRS from the target UE 220 based on the UE mobility profile. For example, if NE 230 is instructed to obtain the CP measurements using center frequency fc with ID #1, NE 230 may receive the UE SRS transmission with a center frequency fc±fd, where fd is defined as Doppler compensation calculated by NE 230 based on the UE mobility. In this case, NE 230 may update the center frequency information of the CP measurements to fc±fd. Hence, NE 230 may update the center frequency information of the UL CP measurement to fc±fd and report the UL CP measurements/measurement set(s) associated with an updated center frequency ID #1 and/or fd.

At operation 210, LMF 250 may estimate the location of target UE 220 using the CP measurements/measurement sets reported by the TRPs and their associated center frequency IDs. In various example embodiments, LMF 250 may use the CP measurements obtained from the PRU SRS transmissions that only have center frequencies similar to the center frequencies of the CP measurements obtained from the UE SRS transmissions.

In various example embodiments, when PRU 240 is a road side unit (RSU) or a TRP, or similar, LMF 250 may instruct PRU 240 with specific center frequency ID configurations for the SRS bandwidth, and may request PRU 240 to obtain CP measurements/measurement sets using these center frequency ID(s) configuration(s) for UL SRS transmitted from the target UE 220.

In certain example embodiments, PRU 240 may be a network entity. For example, PRU 240 may be an RSU or TRP. PRU 240 may report the UL SRS configurations(s) used for the above SRS transmission(s) to LMF 250 to define corresponding center frequency IDs configurations for UL SRS.

FIG. 3 illustrates an example of a signaling diagram 300 depicting a DL CPP UE-based mode. Target UE 320 and PRU 340 may be similar to UE 920. NE 330 (e.g., gNB, or TRPs of a gNB) and LMF 350 may be similar to NE 910 and, as illustrated in FIG. 9, according to certain example embodiments.

At operation 301, DL CPP may be initiated between target UE 320, NE 330, PRU 340, and LMF 350.

At operation 302, LMF 350 may determine a DL PRS configuration within a PFL and a set of specific center frequency IDs within the PFL for CP measurement and may transmit this information to target UE 320 and/or PRU 340.

In some example embodiments, subject to the network's capability, NE 330 may transmit to target UE 320 and/or PRU 340 the PRS configurations for every PRS RB and/or with PRS configurations for odd/even PRS RBs. LMF 350 may need to know the PRS configurations used for PRS transmissions to target UE 320 and/or PRU 340 to define the specific center frequency IDs configurations that target UE 320 and/or PRU 340 may use to obtain the DL CP measurements. At operations 303 and 304, NE 330 may transmit the DL PRS resources to target UE 320 and/or PRU 340, respectively.

In an example embodiment, LMF 350 may transmit a request to target UE 320 and/or PRU 340 to perform the DL CP measurements. In certain example embodiments, such as that illustrated in FIG. 3, the request may include a specific center frequency ID. Specifically, at operation 305, LMF 350 may transmit specific center frequency ID configurations for the DL PRS PFL to target UE 320, and may request target UE 320 to obtain DL CP measurements using specific center frequency ID configurations.

In some example embodiments, LMF 350 may transmit specific center frequency ID configurations for the DL PRS PFL to PRU 340, and request PRU 340 to obtain and report DL CP measurements using specific center frequency ID configurations. In various example embodiments, a UE may perform RSCP measurements from a PRS transmitted from a specific TRP, and/or may perform RSCPD measurements from multiple PRSs transmitted from two or more TRPs.

In some example embodiments, LMF 350 may provide target UE 320 and/or PRU 340 with a pool of center frequency IDs per PFL, where target UE 320 and/or PRU 340, subject to their capabilities, may only be allowed to obtain the CP measurements using these center frequency IDs, where each center frequency ID is used to obtain a single CP measurement. Each center frequency ID may represent the center frequency ID of a part of the DL PRS PFL.

In various example embodiments, LMF 350 may provide target UE 320 and/or PRU 340 with the center frequency of the DL PRS PFL and a granularity step 4, where target UE 320 and/or PRU 340, subject to their capabilities, may obtain the CP measurements only using quantized center frequencies determined by fc±n Δ, where fc is the center frequency of the DL PRS PFL and n is the CP measurement ID. For example, CP measurement #1 may be obtained using center frequency fc±1*Δ, and CP measurement #2 can be obtained using center frequency fc±2*Δ. Here, Δ may be defined as the SCS and/or an integer multiple of the SCS.

At operation 306, PRU 340 may obtain CP measurements/measurement sets for multiple TRPs, and at operation 307, may report them and the associated center frequency ID(s) to LMF 350.

At operation 308, LMF 350 may forward the reported PRU CP measurements/measurement set(s) along with the corresponding center frequency ID(s) to target UE 320.

At operation 309, LMF 350 may instruct target UE 320 to use the PRU CP measurements that have specific center frequency ID(s) to create the double-differenced CP measurements. For example, LMF 350 may instruct target UE 320 to use the PRU CP measurements that have the same center frequency ID(s) as center frequency ID(s) of the DL CP measurements performed by the UE or separated from the center frequency ID(s) of the DL CP measurements performed by the UE with a specific threshold that may be defined or configured by LMF 350 based on UE mobility profile or similar. LMF 350 may indicate a CP technique (e.g., UE-assisted or UE-based).

At operation 310, target UE 320 may use the double-differenced CP measurements, known locations of TRPs and PRU 340 to estimate its location.

In certain example embodiments, LMF may transmit to target UE 320 and/or PRU 340 a pool of center frequency IDs, where target UE 320 and/or PRU 340 can obtain a set of CP measurements using a certain frequency ID. When CP measurements are obtained using contiguous RBs of PRS, center frequency ID #1 can be used to obtain CP measurement set #1 that contains CP measurement #1 obtained from PRS resource #1 transmitted from TRP X, and CP measurement #2 obtained from PRS resource #2 transmitted from TRP Y, where PRS resource #1 and PRS resource #2 belong to the same PFL. As another example, when CP measurements are obtained using non-contiguous RBs of PRS, center frequency ID #1 can be used to obtain CP measurement set #1 that contains CP measurement #1 from PRS RBs #{1 and 3} transmitted from TRP X, and CP measurement #2 from PRS RBs #{2 and 4} transmitted from TRP Y. PRS resources #{1,2,3, and 4} may be in the same PFL. Target UE 320 and/or PRU 340, subject to their capabilities, may report multiple or single CP measurements per PFL using different configurations of PRS resource(s)/resource set(s). In that case, target UE 320 and/or PRU 340 may report different CP measurements/measurement sets, and each one is associated with the corresponding center frequency ID(s) of the PRS resource(s)/resource set(s) used to obtain these measurements/measurement sets. LMF 350 may also provide target UE 320 and PRU 340 with the assistance data for positioning including the PRS configuration information.

FIG. 4 illustrates an example of a signaling diagram 400 depicting a DL CPP UE-assisted mode. Target UE 410 and PRU 430 may be similar to UE 920. NE 420 (e.g., gNB, or TRPs of a gNB) and LMF 440 may be similar to NE 910 and, as illustrated in FIG. 9, according to certain example embodiments.

Operations 401-407 may be similar to operations 301-307, as discussed above, except that at 405, LMF 440 may request target UE 410 to report CP measurement performed by target UE 410.

At operation 408, target UE 410 and PRU 430 may obtain DL CP measurements/measurement set(s) and report them along with the corresponding center frequency IDs to LMF 440. Target UE 410, subject to its capability, may report updated center frequency information of the DL CP measurements based on its mobility profile. For example, if target UE 410 is instructed to obtain the CP measurements using center frequency fc with ID #1, target UE 410 may receive the DL PRS resources at center frequency fc±fd, where fd is defined as the Doppler compensation calculated by target UE 410 based on its mobility profile. Thus, target UE 410 may update the center frequency information of the CP measurements based on center frequency ID #1 and fd, where center frequency ID #1 corresponds to center frequency fc and the updated center frequency of the CP measurements is given by fc±fd.

At operation 409, LMF 440 may use the DL CP measurements/measurement sets received from target UE 410 and/or PRU 430 with the same center frequency ID(s) to calculate the double-differential measurements and estimate the location of target UE 410. For example, LMF 440 may need to cancel the received DL CP measurements/measurement set(s) provided by the PRU that have center frequency ID(s) different than those associated with the target DL CP measurements/measurement set(s) provided by the UE.

FIG. 5 illustrates an example of a flow diagram of a method 500 that may be performed by a LMF, similar to NE 910 illustrated in FIG. 9, according to various example embodiments.

At step 501, the method may include transmitting, by a LMF, to at least one of a network entity or a UE, a request to obtain at least one CP measurement using at least one center frequency identifier configuration for at least one PRS, wherein the at least one PRS comprises at least one UL SRS or DL PRS.

In certain example embodiments, the method may further include receiving, by the LMF from the network entity, at least one UL SRS configuration configured for at least one of a UE or a positioning reference unit SRS transmission; determining, by the LMF, the at least one center frequency identifier configuration for the at least one UL SRS; transmitting, by the LMF, to the network entity, the determined at least one center frequency identifier configuration; receiving, by the LMF, from the network entity, at least one CP measurement associated with at least one center frequency identifier configured by the at least one center frequency identifier configuration, and the at least one associated center frequency identifier; and estimating, by the LMF, the location of the UE using the at least one CP measurement and the at least one associated center frequency identifier.

In some example embodiments, the method may further include determining, by the LMF, a DL PRS configuration within a PFL and the at least one center frequency identifier configuration for the DL PRS comprising a set of center frequency identifiers within the PFL for CP measurement; and transmitting, by the LMF, the determined at least one center frequency identifier configuration to a UE or a PRU to obtain one or more CP measurements based on the at least one center frequency ID configuration.

In various example embodiments, the method may further include receiving, by the LMF, from the positioning reference unit the one or more CP measurements performed by the positioning reference unit associated with at least one center frequency identifier configured by the at least one center frequency identifier configuration, and the at least one associated center frequency identifier.

In certain example embodiments, the method may further include transmitting, by the LMF, to the UE the one or more CP measurements and the associated at least one center frequency identifier received from the positioning reference unit.

In some example embodiments, the method may further include transmitting, by the LMF, to the UE an instruction to use the one or more CP measurements obtained from the positioning reference unit with the associated at least one center frequency identifier to create at least one double-differenced CP measurement.

In various example embodiments, the method may further include receiving, by the LMF, from the UE the one or more CP measurements performed by the UE associated with at least one center frequency identifier configured by the at least one center frequency identifier configuration, and the associated at least one center frequency identifier; and estimating, by the LMF, the location of the UE based on at least the one or more CP measurements of the UE and the at least one or more CP measurements of the positioning reference unit and their associated center frequency identifiers.

FIG. 6 illustrates an example of a flow diagram of a method 600 that may be performed by a UE, such as UE 920 illustrated in FIG. 9, according to various example embodiments.

At step 601, the method may include receiving, by a UE, at least one center frequency identifier configuration for a DL PRS within a PFL.

At step 602, the method may further include receiving, by the UE, a request to perform CP measurement based on the at least one center frequency identifier configuration.

In certain example embodiments, the method may further include performing, by the UE, at least one CP measurement associated with at least one center frequency ID configured by the at least one center frequency identifier configuration.

In some example embodiments, the method may further include providing, by the UE, to a LMF, the at least one CP measurement and the at least one center frequency identifier associated with the at least one CP measurement.

In various example embodiments, the method may further include receiving, by the UE, from a LMF one or more CP measurements of a PRU and at least one center frequency ID associated with the one or more CP measurements of the PRU.

In certain example embodiments, the method may further include receiving, by the UE, from a LMF, an instruction to use the one or more CP measurements of the PRU and the associated at least one center frequency ID to create at least one double-differenced CP measurement.

In some example embodiments, the method may further include estimating, by the UE its location using at least one of the at least one CP measurement obtained by the UE or one or more CP measurements obtained by a PRU and their associated center frequency ID(s).

FIG. 7 illustrates an example of a flow diagram of a method 700 that may be performed by a NE, such as NE 910 illustrated in FIG. 9, according to various example embodiments.

At step 701, the method may include transmitting to a LMF, by a network entity, UL SRS configuration configured for at least one of a UE or a PRU UL SRS transmission.

At step 702, the method may further include receiving from the LMF, by the network entity, at least one center frequency identifier configuration for the UL SRS.

At step 703, the method may further include receiving from the LMF, by the network entity, a request to obtain one or more CP measurements based on the at least one center frequency identifier configuration.

At step 704, the method may further include performing one or more CP measurements associated with at least one center frequency ID configured by the at least one center frequency identifier configuration for the UL SRS.

At step 705, the method may further include transmitting to the LMF, by the network entity, the one or more measurements and the associated at least one center frequency ID.

In certain example embodiments, the network entity may include a gNB, a transmission reception point (TRP), or a PRU operating as a road side unit (RSU) or a TRP.

FIG. 8 illustrates an example of a flow diagram of a method 800 that may be performed by a PRU, such as UE 920 illustrated in FIG. 9, according to various example embodiments.

At step 801, the method may include receiving, from a LMF, by a positioning reference unit, at least one center frequency identifier configuration for a DL PRS within a PFL.

At step 802, the method may further include receiving, by the positioning reference unit, a request to perform CP measurement based on the at least one center frequency identifier configuration.

At step 803, the method may further include performing, by the positioning reference unit, at least one CP measurement associated with at least one center frequency ID configured by the at least one center frequency identifier configuration.

At step 804, the method may further include transmitting, by the positioning reference unit, to the LMF a report on the at least one CP measurement and the associated at least one center frequency ID for the at least one CP measurement.

FIG. 9 illustrates an example of a system according to certain example embodiments. In one example embodiment, a system may include multiple devices, such as, for example, NE 910 and/or UE 920.

NE 910 may be one or more of a base station (e.g., 3G UMTS NodeB, 4G LTE Evolved NodeB, or 5G NR Next Generation NodeB), a serving gateway, a server, and/or any other access node or combination thereof.

NE 910 may further include at least one gNB-centralized unit (CU), which may be associated with at least one gNB-distributed unit (DU). The at least one gNB-CU and the at least one gNB-DU may be in communication via at least one F1 interface, at least one Xn-C interface, and/or at least one NG interface via a 5^{th} generation core (5GC).

UE 920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 910 and/or UE 920 may be one or more of a citizens broadband radio service device (CBSD).

NE 910 and/or UE 920 may include at least one processor, respectively indicated as 911 and 921. Processors 911 and 921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 912 and 922. The memory may be fixed or removable. The memory may include computer program instructions or computer code contained therein. Memories 912 and 922 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 911 and 921, memories 912 and 922, and any subset thereof, may be configured to provide means corresponding to the various blocks of FIGS. 2-8. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 9, transceivers 913 and 923 may be provided, and one or more devices may also include at least one antenna, respectively illustrated as 914 and 924. The device may have many antennas, such as an array of antennas configured for MIMO communications, or multiple antennas for multiple RATs. Other configurations of these devices, for example, may be provided. Transceivers 913 and 923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 2-8). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 2-8. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to NE 910 and UE 920, respectively. The user plane function (UPF) may provide services such as intra-RAT and inter-RAT mobility, routing and forwarding of data packets, inspection of packets, user plane quality of service (QOS) processing, buffering of DL packets, and/or triggering of DL data notifications. The application function (AF) may primarily interface with the core network to facilitate application usage of traffic routing and interact with the policy framework.

According to certain example embodiments, processors 911 and 921, and memories 912 and 922, may be included in or may form a part of processing circuitry or control circuitry. In addition, in some example embodiments, transceivers 913 and 923 may be included in or may form a part of transceiving circuitry.

In some example embodiments, an apparatus (e.g., NE 910 and/or UE 920) may include means for performing a method, a process, or any of the variants discussed herein. Examples of the means may include one or more processors, memory, controllers, transmitters, receivers, and/or computer program code for causing the performance of the operations.

In various example embodiments, apparatus 910 may be controlled by memory 912 and processor 911 to transmit, to at least one of a network entity or a UE, a request to obtain at least one CP measurement using at least one center frequency identifier configuration for at least one PRS, wherein the at least one PRS comprises at least one UL SRS or DL PRS.

Certain example embodiments may be directed to an apparatus that includes means for performing any of the methods described herein including, for example, means for transmitting, to at least one of a network entity or a UE, a request to obtain at least one CP measurement using at least one center frequency identifier configuration for at least one PRS, wherein the at least one PRS comprises at least one UL SRS or DL PRS.

In various example embodiments, apparatus 920 may be controlled by memory 922 and processor 921 to receive at least one center frequency identifier configuration for a DL PRS within a PFL; and receive a request to perform CP measurement based on the at least one center frequency identifier configuration.

Certain example embodiments may be directed to an apparatus that includes means for performing any of the methods described herein including, for example, means for receiving at least one center frequency identifier configuration for a DL PRS within a PFL; and means for receiving a request to perform CP measurement based on the at least one center frequency identifier configuration.

In various example embodiments, apparatus 910 may be controlled by memory 912 and processor 911 to transmit to a LMF UL SRS configuration configured for at least one of a UE or a PRU UL SRS transmission; receive from the LMF at least one center frequency identifier configuration for the UL SRS; receive from the LMF a request to obtain one or more CP measurements based on the at least one center frequency identifier configuration; perform one or more CP measurements associated with at least one center frequency ID configured by the at least one center frequency identifier configuration for the UL SRS; and transmit to the LMF the one or more measurements and the associated at least one center frequency ID.

Certain example embodiments may be directed to an apparatus that includes means for performing any of the methods described herein including, for example, means for transmitting to a LMF UL SRS configuration configured for at least one of a UE or a PRU UL SRS transmission; receiving from the LMF at least one center frequency identifier configuration for the UL SRS; receiving from the LMF a request to obtain one or more CP measurements based on the at least one center frequency identifier configuration; performing one or more CP measurements associated with at least one center frequency ID configured by the at least one center frequency identifier configuration for the UL SRS; and transmitting to the LMF the one or more measurements and the associated at least one center frequency ID.

In various example embodiments, apparatus 920 may be controlled by memory 922 and processor 921 to receive, from a LMF at least one center frequency identifier configuration for a DL PRS within a PFL; receive a request to perform CP measurement based on the at least one center frequency identifier configuration; perform at least one CP measurement associated with at least one center frequency ID configured by the at least one center frequency identifier configuration; and transmit to the LMF a report on the at least one CP measurement and the associated at least one center frequency ID for the at least one CP measurement.

Certain example embodiments may be directed to an apparatus that includes means for performing any of the methods described herein including, for example, means for receiving, from a LMF at least one center frequency identifier configuration for a DL PRS within a PFL; means for receiving a request to perform CP measurement based on the at least one center frequency identifier configuration; means for performing at least one CP measurement associated with at least one center frequency ID configured by the at least one center frequency identifier configuration; and means for transmitting to the LMF a report on the at least one CP measurement and the associated at least one center frequency ID for the at least one CP measurement.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3^{rd} Generation Partnership Project
5G 5^{th} Generation
5GC 5^{th} Generation Core
6G 6^{th} Generation
AF Application Function
AMF Access and Mobility Management Function
ASIC Application Specific Integrated Circuit
CBSD Citizens Broadband Radio Service Device
CC Component Carrier
CP Carrier Phase
CPP Carrier Phase Positioning
CPU Central Processing Unit
CU Centralized Unit
DL Downlink
DU Distributed Unit
eMBB Enhanced Mobile Broadband
eNB Evolved Node B
gNB Next Generation Node B
GPS Global Positioning System
HDD Hard Disk Drive
IoT Internet of Things
LMF Location Management Function
LTE Long-Term Evolution
LTE-A Long-Term Evolution Advanced
MEMS Micro Electrical Mechanical System
MIMO Multiple Input Multiple Output
mMTC Massive Machine Type Communication
NE Network Entity
NG Next Generation
NG-eNB Next Generation Evolved Node B
NG-RAN Next Generation Radio Access Network
NR New Radio
NR-U New Radio Unlicensed
PDA Personal Digital Assistance
PFL Positioning Frequency Layer
PRS Positioning Reference Signal
PRU Positioning Reference Unit
QoS Quality of Service
RAM Random Access Memory
RAN Radio Access Network
RAT Radio Access Technology
RB Resource Block
RF Radio Frequency
ROM Read-Only Memory
RRC Radio Resource Control
RRM Radio Resource Management
RRU Remote Radio Unit
RS Reference Signal
RSCP Reference Signal Carrier Phase
RSCPD Reference Signal Carrier Phase Difference
RSU Roadside Unit
RSTD Reference Signal Time Difference
RTOA Relative Time of Arrival
SCS Sub-Carrier Spacing
SRS Sounding Reference Signal
TDOA Time Difference of Arrival
TRP Transmission Reception Point
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network

1-51. (canceled)

52. An apparatus comprising:
at least one processor; and
at least one memory storing instructions that, when executed by the at least one processor, cause the apparatus at least to:
transmit, to at least one of a network entity or a user equipment, a request to obtain at least one carrier phase measurement using at least one center frequency identifier configuration for at least one positioning reference signal, wherein the at least one positioning reference signal comprises at least one uplink sounding reference signal or downlink positioning reference signal.

53. The apparatus of claim 52, wherein the instructions, when executed by the at least one processor, further cause the apparatus at least to:
receive, from the network entity, at least one uplink sounding reference signal configuration configured for at least one of a user equipment or a positioning reference unit sounding reference signal transmission;
determine the at least one center frequency identifier configuration for the at least one uplink sounding reference signal;
transmit, to the network entity, the determined at least one center frequency identifier configuration;
receive, from the network entity, at least one carrier phase measurement associated with at least one center frequency identifier configured by the at least one center frequency identifier configuration, and the at least one associated center frequency identifier; and
estimate, the location of the user equipment using the at least one carrier phase measurement and the at least one associated center frequency identifier.

54. The apparatus of claim 52, wherein the instructions, when executed by the at least one processor, further cause the apparatus at least to:
determine, a downlink positioning reference signal configuration within a positioning frequency layer and the at least one center frequency identifier configuration for the downlink positioning reference signal comprising a set of center frequency identifiers within the positioning frequency layer for carrier phase measurement;
transmit, the determined at least one center frequency identifier configuration to a user equipment or a positioning reference unit to obtain one or more carrier phase measurements based on the at least one center frequency identifier configuration.

55. The apparatus of claim 54, wherein the instructions, when executed by the at least one processor, further cause the apparatus at least to:
receive from the positioning reference unit the one or more carrier phase measurements performed by the positioning reference unit associated with at least one center frequency identifier configured by the at least one center frequency identifier configuration, and the at least one associated center frequency identifier.

56. The apparatus of claim 55, wherein the instructions, when executed by the at least one processor, further cause the apparatus at least to:
transmit to the user equipment the one or more carrier phase measurements and the associated at least one center frequency identifier received from the positioning reference unit.

57. The apparatus of claim 56, wherein the instructions, when executed by the at least one processor, further cause the apparatus at least to:
transmit to the user equipment an instruction to use the one or more carrier phase measurements obtained from the positioning reference unit with the associated at least one center frequency identifier to create at least one double-differenced carrier phase measurement.

58. The apparatus of claim 55, wherein the instructions, when executed by the at least one processor, further cause the apparatus at least to:
receive from the user equipment the one or more carrier phase measurements performed by the user equipment associated with at least one center frequency identifier configured by the at least one center frequency identifier configuration, and the associated at least one center frequency identifier; and
estimate the location of the user equipment based on at least the one or more carrier phase measurements of the user equipment and the at least one or more carrier phase measurements of the positioning reference unit and their associated center frequency identifiers.

59. An apparatus comprising:
at least one processor; and
at least one memory storing instructions that, when executed by the at least one processor, cause the apparatus at least to:
receive at least one center frequency identifier configuration for a downlink positioning reference signal within a positioning frequency layer; and
receive a request to perform carrier phase measurement based on the at least one center frequency identifier configuration.

60. The apparatus of claim 59, wherein the instructions, when executed by the at least one processor, further cause the apparatus at least to:
perform at least one carrier phase measurement associated with at least one center frequency identifier configured by the at least one center frequency identifier configuration.

61. The apparatus of claim 60, wherein the instructions, when executed by the at least one processor, further cause the apparatus at least to:
provide, to a location management function, the at least one carrier phase measurement and the at least one center frequency identifier associated with the at least one carrier phase measurement.

62. The apparatus of claim 60, wherein the instructions, when executed by the at least one processor, further cause the apparatus at least to:
receive from a location management function one or more carrier phase measurements of a positioning reference unit and at least one center frequency identifier associated with the one or more carrier phase measurements of the positioning reference unit.

63. The apparatus of claim 62, wherein the instructions, when executed by the at least one processor, further cause the apparatus at least to:
receive, from a location management function, an instruction to use the one or more carrier phase measurements of the positioning reference unit and the associated at least one center frequency identifier to create at least one double-differenced carrier phase measurement.

64. The apparatus of claim 59, wherein the instructions, when executed by the at least one processor, further cause the apparatus at least to:
estimate a location of the apparatus using at least one of the at least one carrier phase measurement obtained by the user equipment or one or more carrier phase measurements obtained by a positioning reference unit and their associated center frequency identifiers.

65. An apparatus comprising:
at least one processor; and
at least one memory storing instructions that, when executed by the at least one processor, cause the apparatus at least to:
transmit to a location management function uplink sounding reference signal configuration configured for at least one of a user equipment or a positioning reference unit uplink sounding reference signal transmission;
receive from the location management function at least one center frequency identifier configuration for the uplink sounding reference signal;
receive from the location management function a request to obtain one or more carrier phase measurements based on the at least one center frequency identifier configuration;
perform one or more carrier phase measurements associated with at least one center frequency identifier configured by the at least one center frequency identifier configuration for the uplink sounding reference signal; and
transmit to the location management function the one or more measurements and the associated at least one center frequency identifier.

66. The apparatus of claim 65, wherein the apparatus comprises a network entity, a transmission reception point, or a positioning reference unit operating as a road side unit or a transmission reception point.
